(19) United States
(12) Patent Application Publication
(10) Pub. No.: US 2026/0278941 A1
(43) Pub. Date: Sep. 17, 2026

(54) DYNAMIC NON-UNIFORM MESH GENERATION FOR EFFICIENT VIRTUAL REALITY FRAME GENERATION

(71) Applicant: Samsung Electronics Co., Ltd., Suwon-si (KR)

(72) Inventors: Ruiliang Gao, Mountain View, CA (US); Aamer Khani, Dublin, CA (US)

(21) Appl. No.: 19/555,662

(22) Filed: Mar. 3, 2026

Related U.S. Application Data
(60) Provisional application No. 63/770,899, filed on Mar. 12, 2025.

(51) Int. Cl. G06T 17/20; G06F 3/01; G06T 3/18

(52) U.S. Cl. CPC G06T 17/205; G06F 3/013; G06T 3/18; G06T 2210/44

(57) ABSTRACT

An electronic device includes a memory and at least one processing device operatively connected to the memory. The at least one processing device is configured to receive contents to be displayed on a display. The at least one processing device is also configured to receive eye-tracking data from an eye-tracking sensor and lens field of view (FOV) data from the memory. The at least one processing device is also configured to generate a mesh using the eye-tracking data and the lens FOV data, wherein the mesh includes a high density area and a low density area, defined based at least partly on the lens FOV data. The at least one processing device is also configured to perform warping of the contents using the mesh. The at least one processing device is also configured to render the contents based on the warping of the contents.

### CROSS-REFERENCE TO RELATED APPLICATION AND PRIORITY CLAIM

This application claims priority under 35 U.S.C. § 119(e) to U.S. Provisional Patent Application No. 63/770,899 filed on Mar. 12, 2025, which is hereby incorporated by reference in its entirety.

### TECHNICAL FIELD

This disclosure relates generally to virtual reality systems. More specifically, this disclosure relates to dynamic non-uniform mesh generation for efficient virtual reality frame generation.

### BACKGROUND

There exist Virtual Reality (VR) performance enhancement techniques, such as SPACEWARP, that enhance motion perception by generating missing frames when the rendering rate falls below the display refresh rate, ensuring a smoother experience even with inconsistent frame rates. By reducing the rendering workload on the CPU and GPU, these VR performance enhancement techniques enable more complex graphics, extended battery life, and better performance on lower-end hardware while minimizing motion sickness. These VR performance enhancement techniques often work by analyzing depth and motion data from previous frames to predict object positions in subsequent frames, extrapolating old frames to create new ones. However, issues with these VR performance enhancement techniques exist. For example, due to computational constraints, VR performance enhancement techniques typically operate on a lower-resolution mesh of grid vertices rather than every pixel, making the quality of the output heavily dependent on the mesh used.

### SUMMARY

This disclosure relates to dynamic non-uniform mesh generation for efficient virtual reality frame generation.

In one embodiment, an electronic device includes a memory and at least one processing device operatively connected to the memory. The at least one processing device is configured to receive contents to be displayed on a display. The at least one processing device is also configured to receive eye-tracking data from an eye-tracking sensor and lens field of view (FOV) data from the memory. The at least one processing device is also configured to generate a mesh using the eye-tracking data and the lens FOV data, wherein the mesh includes a high density area and a low density area, defined based at least partly on the lens FOV data. The at least one processing device is also configured to perform warping of the contents using the mesh. The at least one processing device is also configured to render the contents based on the warping of the contents.

In another embodiment, a method includes receiving, by at least one processor of an electronic device, contents to be displayed on a display. The method also includes receiving, by the at least one processor, eye-tracking data from an eye-tracking sensor and lens field of view (FOV) data from a memory of the electronic device. The method also includes generating, by the at least one processor, a mesh using the eye-tracking data and the lens FOV data, wherein the mesh includes a high density area and a low density area, defined based at least partly on the lens FOV data. The method also includes performing, by the at least one processor, warping of the contents using the mesh. The method also includes rendering, by the at least one processor, the contents based on the warping of the contents.

In another embodiment, a non-transitory machine-readable medium contains instructions that when executed cause at least one processor of an electronic device to receive contents to be displayed on a display, receive eye-tracking data from an eye-tracking sensor and lens field of view (FOV) data from a memory, generate a mesh using the eye-tracking data and the lens FOV data, wherein the mesh includes a high density area and a low density area, defined based at least partly on the lens FOV data, perform warping of the contents using the mesh, and render the contents based on the warping of the contents.

Any single one or any combination of the following features may be used with the above embodiments. Density clamping may be performed to define the high density area of the mesh while maintaining a smooth transition between the high density area and the low density area. A low degree polynomial function may be used for computing a non-uniform density of the mesh, while incorporating the eye-tracking data and lens FOV data for determining a mesh density center and radius. The non-uniform density of the mesh may be computed using a target density value defining a target density and target size of a center area of the mesh corresponding to the mesh density center. To generate the mesh a mesh center location and weights may be extracted, based at least partly on the eye-tracking data and lens FOV data, the low degree polynomial function may be evaluated to output a smooth distribution of mesh points, the density clamping may be applied to the high density area, and updated mesh positions may be output. The updated mesh positions may include vertex positions and horizonal and vertical (UV) coordinates. Depth reprojection and binning may be performed for generating new image frames using the updated mesh positions.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device in accordance with this disclosure;

FIG. 2 illustrates an example VR performance enhancement processing architecture in accordance with this disclosure;

FIG. 3 illustrates an example dynamic mesh generation and dynamic binning process in accordance with this disclosure;

FIG. 4 illustrates an example dynamic mesh generation process in accordance with this disclosure;

FIG. 5 illustrates an example uniform density grid with lens distortion correction;

FIGS. 6A and 6B illustrate an example non-uniform grid in accordance with this disclosure;

FIG. 7 illustrates an example non-uniform mesh creation process in accordance with this disclosure;

FIGS. 8A and 8B illustrate an example non-uniform grid in accordance with this disclosure;

FIG. 9 illustrates an example non-uniform mesh creation process incorporating gaze data and a target density in accordance with this disclosure;

FIG. 10 illustrates an example dynamic binning process in accordance with this disclosure; and

FIG. 11 illustrates an example method for dynamic non-uniform mesh generation in accordance with this disclosure.

### DETAILED DESCRIPTION

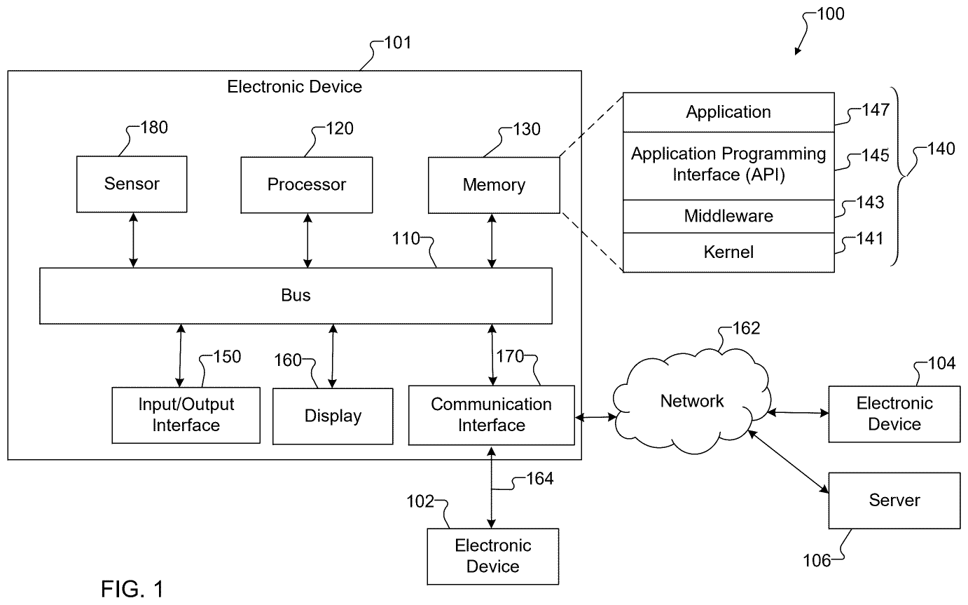

FIGS. 1 through 11, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, there exist Virtual Reality (VR) performance enhancement techniques, such as SPACEWARP, that enhance motion perception by generating missing frames when the rendering rate falls below the display refresh rate, ensuring a smoother experience even with inconsistent frame rates. By reducing the rendering workload on the CPU and GPU, these VR performance enhancement techniques enable more complex graphics, extended battery life, and better performance on lower-end hardware while minimizing motion sickness. These VR performance enhancement techniques often work by analyzing depth and motion data from previous frames to predict object positions in subsequent frames, extrapolating old frames to create new ones. However, issues with these VR performance enhancement techniques exist.

For example, due to computational constraints, VR performance enhancement techniques typically operate on a lower-resolution mesh of grid vertices rather than every pixel, making the quality of the output heavily dependent on the mesh used. This disclosure provides various improvements on improving these VR performance enhancement techniques by implementing improved mesh generation algorithms and integrating eye-tracking to enhance both quality and efficiency. This disclosure addresses various issues in existing techniques, including the lack of gaze tracking in existing methods which limits accuracy by relying on uniform mesh resolution, despite the human eye's narrow focus range (40-50 degrees), suboptimal uniform meshes due to lens distortion, and refining them with geometry and tessellation shaders is too resource-intensive for mobile GPUs, and visual artifacts during fast motion or with overlapping objects degrade the VR experience. This disclosure provides for creating an optimal mesh that improves the performance of VR performance enhancement techniques while incorporating eye-tracking for better computational efficiency.

Existing solutions provide an HMD designed to be worn on a user's head and include see-through cameras facing forward, a motion sensor (e.g., IMU), a depth sensor (e.g., time of flight (ToF) or Lidar), and an eye-tracking sensor. A processor of the HDM is configured to receive display content, eye-tracking data, lens field of view (FOV) data, and optionally a target density value. The processor then transforms the content using a space-warping process with a mesh that has high and low density areas, defined partly by the FOV data. The transformed content is rendered for display. Additional features include using a density clamp function to define the high-density area with a gradual transition and employing a low-degree polynomial function (e.g., bi-cubic) to compute the mesh's non-uniform density, incorporating eye-tracking and FOV data to determine the mesh's density center and radius.

Various embodiments of this disclosure provide superior performance in terms of power, CPU, and GPU efficiency compared other techniques and/or algorithms. The key difference among existing solutions lies in their mesh handling, as they tend to use mesh refinement with tessellation, while the various embodiments of this disclosure employ a non-uniform mesh without tessellation, reducing GPU workload. Moreover, the various embodiments of this disclosure operate primarily at the vertex shader stage, minimizing resource usage. Accuracy tests have confirmed that the solutions of this disclosure provide a highest performance under head translation, with optimal quality in the user's gaze area despite slightly lower quality at boundaries.

Note that while some of the embodiments discussed below are described in the context of use in consumer electronic devices (such as HMDs), this is merely one example. It will be understood that the principles of this disclosure may be implemented in any number of other suitable contexts and may use any suitable device or devices. It will be understood that the principles of this disclosure may be implemented using any number of devices. In general, this disclosure is not limited to use with any specific type(s) of device(s).

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to dynamic non-uniform mesh generation for efficient virtual reality frame generation.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to dynamic non-uniform mesh generation for efficient virtual reality frame generation. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to dynamic non-uniform mesh generation for efficient virtual reality frame generation.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

In the field of VR, performance enhancement techniques, like SPACEWARP, are used because they allow for smoother motion perception by essentially “filling in” missing frames when the rendering rate is lower than the display refresh rate, resulting in a more fluid experience even when a game or application can't consistently render at the full frame rate required for optimal visuals. By rendering fewer frames, these VR performance enhancement techniques can significantly reduce the workload on the CPU and GPU, allowing for more complex graphics or longer battery life. It can also help improve performance on lower-end hardware, minimizing the motion sickness issue. These VR performance enhancement techniques often work by analyzing previous frames' depth and motion information and predicting where objects should be in the next frame, allowing the system to “extrapolate” the old frames for new frames. In order to get the most accurate output, ideally, every single pixel would be extrapolated on from the old frames to generate new frames. However, due to the constraint on computational resources, extrapolating every pixel is impractical and the industrial standard way is to apply VR performance enhancement techniques on a lower resolution mesh formed by a discrete set of grid vertices. Therefore, the quality of the VR performance enhancement technique output heavily relies on the underlying mesh used in the algorithm.

As explained herein, this disclosure focuses on the mesh generation algorithm for improving VR performance enhancement quality and integrating eye-tracking into the VR performance enhancement module quality and computational efficiency. This invention aims to generate the optimal mesh for improving VR performance enhancement algorithms. More specifically, this disclosure solves various problems, including: 1) The existing approaches do not incorporate gaze tracking functionality, and therefore the accuracy is limited by the overall mesh resolution—given that the human eye focus is actually about 40 to 50 degree, it is not wise to spend computational resources uniformly for the entire field of view; 2) the existing approaches use a uniform mesh as input, which is not a good approach when taking lens distortion into consideration, and performing mesh refinement using geometry and tessellation shaders tend to be too costly on mobile GPUs such that the target FPS cannot be reached without late frames for heavy applications; and 3) the noticeable visual artifacts on fast motion cases or overlapping objects in the scene cause an uncomfortable VR experience.

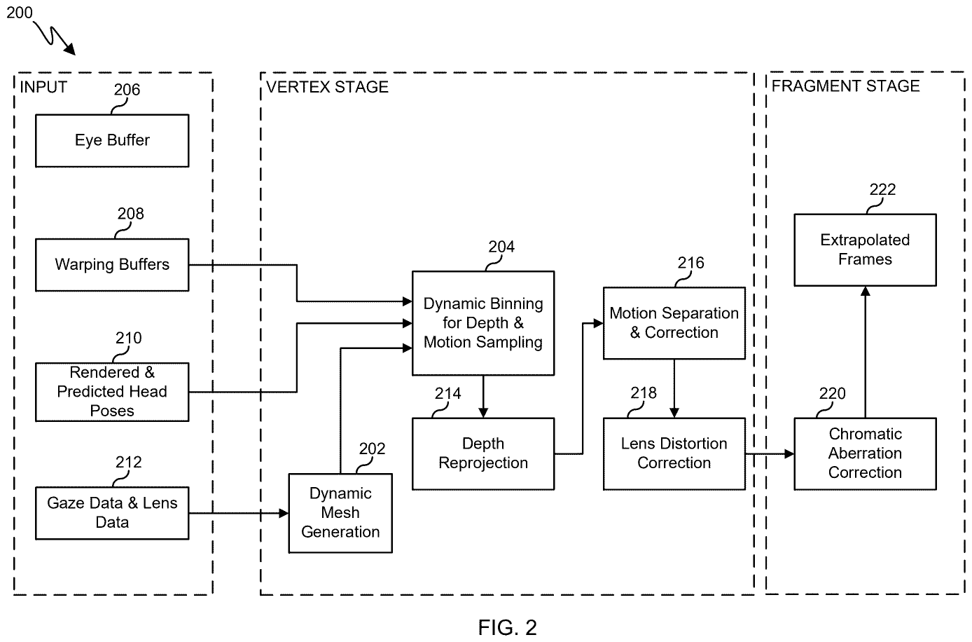

FIG. 2 illustrates an example VR performance enhancement processing architecture 200 in accordance with this disclosure. For ease of explanation, the architecture 200 shown in FIG. 2 is described as being implemented on or supported by the electronic device 101 in the network configuration 100 of FIG. 1. However, the architecture 200 shown in FIG. 2 could be used with any other suitable device(s) and in any other suitable system(s).

As shown in FIG. 2, during a vertex stage of the architecture 200, a dynamic mesh generation operation 202 for generating a dynamic mesh and a dynamic binning operation 204 for depth and motion sampling are used to provide the above-described improvements to VR performance enhancement. The architecture 200 takes various inputs such as an eye buffer 206, warping buffers 208, rendered and predicted head poses 210, and gaze data and lens data 212.

In various embodiments of this disclosure, the dynamic mesh generation operation 202 uses a bi-cubic mesh density function for generating a non-uniform mesh, incorporating eye-tracking and lens FOV data for determining a mesh density center and radius. The dynamic mesh generation operation 202 also uses a density clamp function to define the high density mesh area while maintaining the smooth transition between high density area and lower density areas. This approach preserves the overall shape and topology of the original mesh, without any requirement for re-meshing or mesh refinement. Introducing the dynamic mesh generation operation 202 that uses the mesh density function to generate the non-uniform mesh improves efficiency because, among the lower degree polynomial choices, bi-cubic polynomials are efficient to evaluate and naturally guarantee smooth transition, providing a good balance of quality and efficiency.

The integration of eye-tracking data and target mesh quality guarantees that no mesh refinement is required. As shown in FIG. 2, the dynamic mesh generation operation 202 and the dynamic binning operation 204 stay stays within the vertex shader stage, which avoids increasing the overall mesh resolution, providing better computation efficiency compared with traditional approaches. Combining the dynamic mesh generation operation 202 with the dynamic binning operation 204 (a dynamic binning-based sampling algorithm) the overall approach of the architecture 200 of this disclosure achieves high accuracy and smoothness within the user gaze area. Overall, this allows for generation of a gaze-based dynamic mesh in a very computationally efficient manner and maintains the smoothness and accuracy in the generated frames.

In various embodiments of this disclosure, the electronic device can be an HMD that includes a housing structure shaped to be worn on a user's head, a pair of external (see-through) cameras coupled to the structure so as to face toward a front side of the structure, a display configured to display an image and/or video to the user wearing the structure, at least one motion sensor (e.g., IMU) positioned inside the structure, at least one depth sensor (e.g., ToF sensor, Lidar) coupled to the structure so as to face toward the front side of the structure, at least one eye-tracking sensor positioned to track the user's eyes, and a processor, such as the processor 120, operatively connected to the cameras, the display, the motion sensor, the depth sensor, and the eye-tracking sensor, and a memory, such as the memory 130, operatively connected to the processor. The electronic device can receive contents to be displayed on the display, eye-tracking data from the eye-tracking sensor, lens field of view (FOV) data from the memory, and optionally a user defined or default target density value. As shown in FIG. 2, the electronic device can perform reprojection of the contents, including a warping process utilizing a mesh created by the dynamic mesh generation operation 202, where the mesh includes a high density area and a low density area, defined based at least partly on the FOV data, and the results can be rendered. Further, the processor can use a density clamp function to define the high density area while maintaining a gradual transition between the high density area and the low density area. In various embodiments of this disclosure, the dynamic mesh generation operation 202 uses a low degree (e.g., bi-cubic) polynomial function for computing a non-uniform density of the mesh, while incorporating the eye-tracking data and lens FOV data for determining the mesh density center and radius.

The processor can further extract a mesh center location and weights, based at least partly on the eye-tracking data and lens FOV data, evaluate the low degree (e.g., bi-cubic) polynomial function to output a smooth distribution of mesh points, apply the density clamp function to the high density area, and output updated mesh positions (e.g., vertex positions and horizonal and vertical (UV) coordinates) to be passed to the dynamic binning operation 204 and a depth reprojection operation 214 for generating new image frames.

As also shown in FIG. 2, the architecture 200 can include, as part of the vertex stage, a motion separation and correction operation 216 that uses buffers (e.g., motion vector buffer, depth buffer) to distinguish motion and performs motion correction by shifting pixels from previous frames to new positions based on the motion vectors. The vertex stage can also include a lens distortion correction operation 218 that counteracts the physical distortion of glass lenses in IMDs. At the fragment stage, a chromatic aberration correction operation 220 can address any issues with chromatic characteristics of the image, and extrapolated frames 222 are output by the processing architecture 200 for display on the electronic device.

Although FIG. 2 illustrates one example of a VR performance enhancement processing architecture 200, various changes may be made to FIG. 2. For example, various components and functions in FIG. 2 may be combined, further subdivided, replicated, or rearranged according to particular needs. Also, one or more additional components and functions may be included if needed or desired.

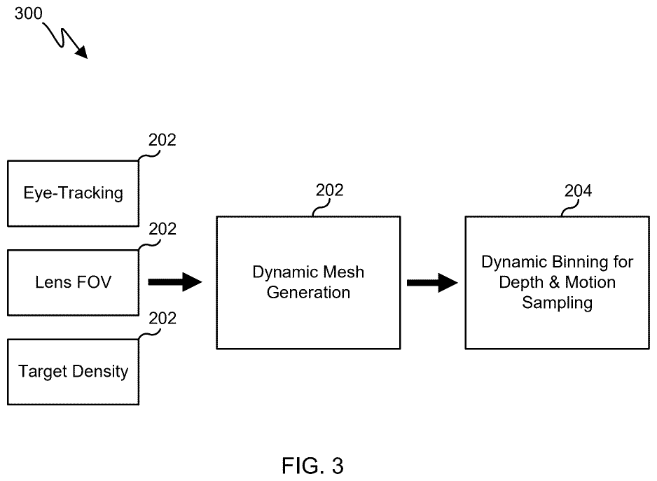

FIG. 3 illustrates an example dynamic mesh generation and dynamic binning process 300 in accordance with this disclosure. For ease of explanation, the process 300 shown in FIG. 3 is described as being implemented on or supported by the electronic device 101 in the network configuration 100 of FIG. 1. However, the process 300 shown in FIG. 3 could be used with any other suitable device(s) and in any other suitable system(s).

As shown in FIG. 3, the process 300 includes extracting inputs from eye-tracking data 302 lens FOV data 304, and, optionally, a target density 306, which, in various embodiments, can be a defined target density value for the mesh generation. As also described with respect to FIG. 2, a dynamic mesh generation operation 202 uses the input data 302, 304, 306 to dynamically generate a non-uniform mesh based on the input data. A generated grid is fit into the rest of the rendering pipeline. Further the dynamic binning operation 204 is used to ensure the quality of output for reprojection.

Although FIG. 3 illustrates one example of a dynamic mesh generation and dynamic binning process 300, various changes may be made to FIG. 3. For example, various functions in FIG. 3 may be combined, further subdivided, replicated, or rearranged according to particular needs. Also, one or more additional functions may be included if needed or desired.

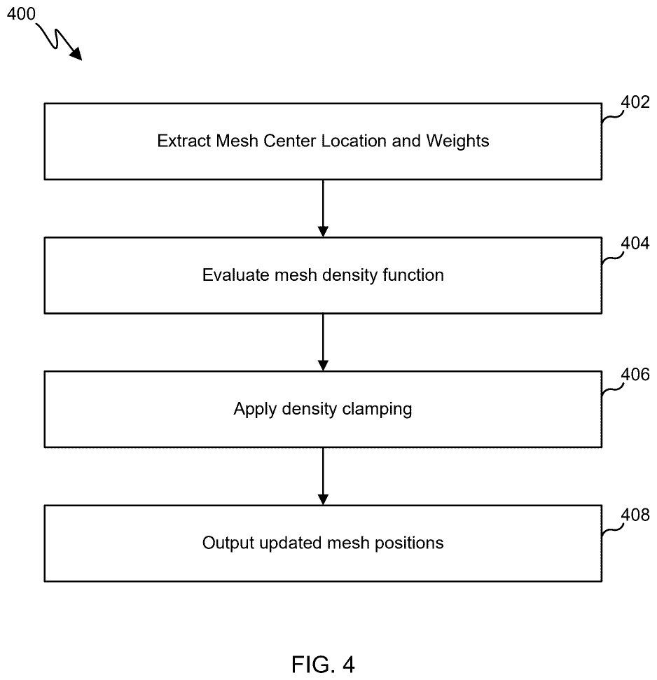

For example, FIG. 4 illustrates an example dynamic mesh generation process 400 in accordance with this disclosure. For ease of explanation, the process 400 shown in FIG. 4 is described as being implemented on or supported by the electronic device 101 in the network configuration 100 of FIG. 1. However, the process 400 shown in FIG. 4 could be used with any other suitable device(s) and in any other suitable system(s). The process 400 can be included as at least a part of the dynamic mesh generation operation 202.

As shown in FIG. 4, the process 400 includes, at step 402, extracting a mesh center location and weights. As described with respect to FIGS. 2 and 3, the process 400 can use three inputs for the mesh generation: lens FOV data, which can include four float values defining the size and asymmetric shape of the lens, eye-tracking gaze information that describes the gaze location for both eyes, and, optionally, a target density that can be a customizable parameter that defines the desired density and size of the central high-quality area of the mesh. Based on these inputs, the mesh center location and weights are computed that describe the number of mesh vertices assigned to each surrounding region of the mesh center.

At step 404, a mesh density function is evaluated. In various embodiments of this disclosure, this can include evaluating the bi-cubic density function to output a smooth distribution of mesh points, which has a higher density around the mesh center and a lower density around the mesh boundaries. In various embodiments, the ordering of the mesh vertices is not modified, allowing for the natural triangulation over the vertices to preserve topology.

At step 406, density clamping is applied to the center area of the mesh. Since the natural density distribution from the bi-cubic polynomial can have large density variations around the center area, which is generally not desirable, the density clamping is performed on the center area of the mesh to maintain a consistent high quality based on the input target density. In various embodiments of this disclosure, step 406 can be achieved by performing a surface-plane intersection operation.

At step 408, updates mesh positions are output. The output updated mesh vertex positions and UV coordinates are passed to the dynamic binning operation 204 and depth re-projection operation for generating new frames.

Although FIG. 4 illustrates one example of a dynamic mesh generation process 400, various changes may be made to FIG. 4. For example, various functions in FIG. 4 may be combined, further subdivided, replicated, or rearranged according to particular needs. Also, one or more additional functions may be included if needed or desired. Also, while shown as a series of steps, various steps in FIG. 4 could overlap, occur in parallel, occur in a different order, or occur any number of times (including zero times).

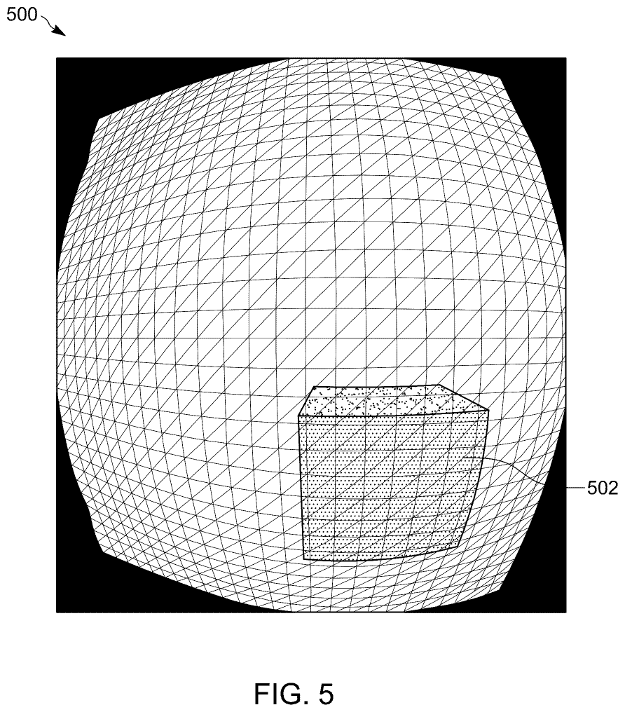

FIG. 5 illustrates an example uniform density grid 500 with lens distortion correction. A uniform density grid like that shown in FIG. 5 cannot provide a high quality output around a central area. With lens distortion effects, this issue becomes more noticeable, as also shown in FIG. 5, and refining them with geometry and tessellation shaders tends to be too resource-intensive for many devices.

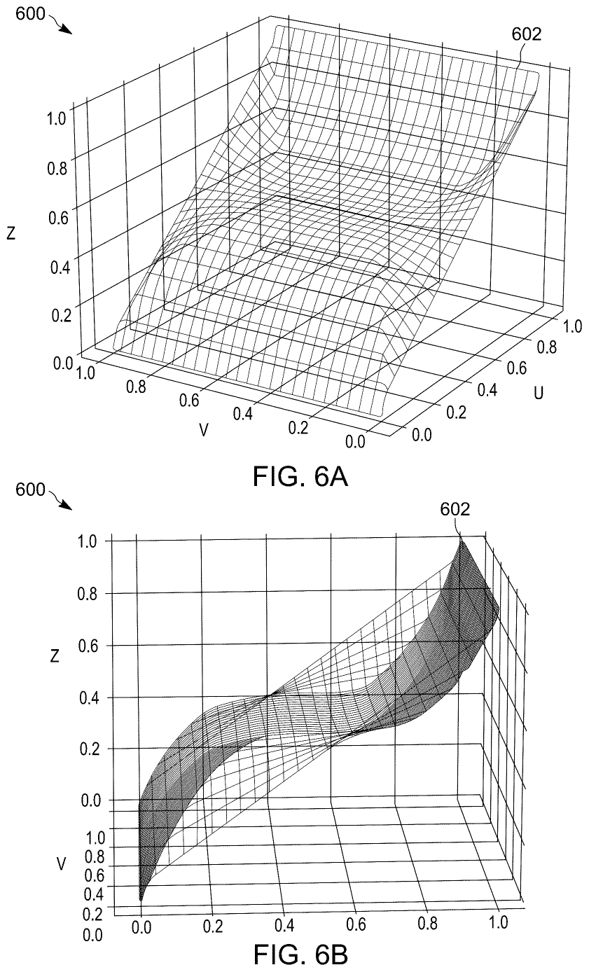

FIGS. 6A and 6B illustrate an example non-uniform grid 600 in accordance with this disclosure. For ease of explanation, the non-uniform grid 600 shown in FIGS. 6A and 6B is described as being implemented on or supported by the electronic device 101 in the network configuration 100 of FIG. 1. However, the non-uniform grid 600 shown in FIGS. 6A and 6B could be used with any other suitable device(s) and in any other suitable system(s).

As shown in FIGS. 6A and 6B, embodiments of this disclosure provide for utilizing a bi-cubic mesh density function on input grid UV coordinates to generate a non-uniform grid, e.g., non-uniform grid 600, that produces a high quality output 602 around the user gaze area, without sacrificing any computation efficiency. FIGS. 6A and 6B show a first variation of the bi-cubic mesh density function. The U coordinates are generated from the bi-cubic mesh density function \vec{ƒ}(u,v).

Although FIGS. 6A and 6B illustrate one example of a non-uniform grid 600, various changes may be made to FIGS. 6A and 6B. For example, although FIGS. 6A and 6B illustrate the grid 600 having an example output 602, the output could be in various shapes, densities, etc., depending on the nature of the image and the resulting mesh.

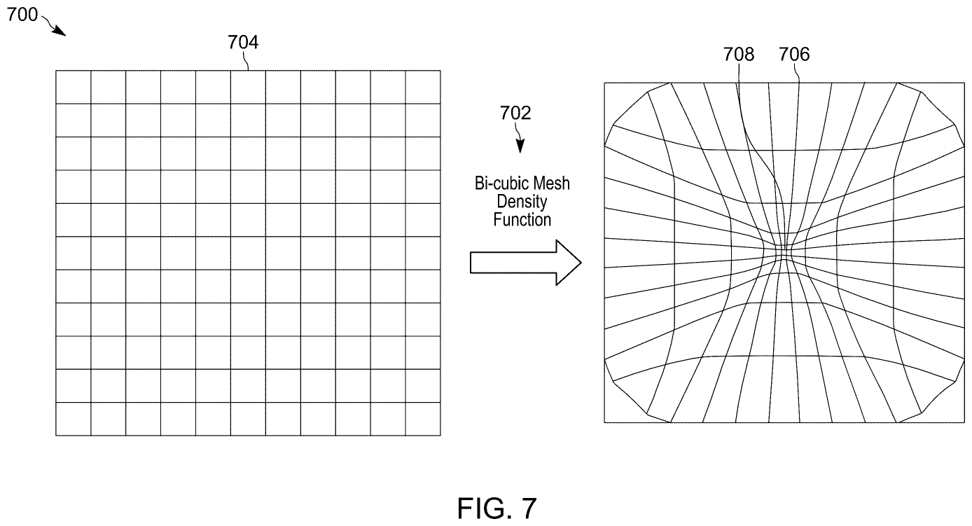

The dynamic mesh generation operation of this disclosure provides for a mesh that has a higher density in a center area compared to a density in areas surrounding the center. For example, FIG. 7 illustrates an example non-uniform mesh creation process 700 in accordance with this disclosure. For ease of explanation, the process 700 shown in FIG. 7 is described as being implemented on or supported by the electronic device 101 in the network configuration 100 of FIG. 1. However, the process 700 shown in FIG. 7 could be used with any other suitable device(s) and in any other suitable system(s). The process 700 can be included as at least a part of the dynamic mesh generation operation 202.

As shown in FIG. 7, a bi-cubic mesh density function 702 is performed on an input mesh 704 to produce a non-uniform mesh 706. As shown in FIG. 7, the resulting non-uniform mesh 706 has a center area 708 that is a higher density than areas surrounding the center area 708. In various embodiments, the density of the non-uniform mesh 706 progressively decreases as it moves away from the center area.

The bi-cubic mesh density function 702 can be represented as \vec{ƒ}(u,v). The bi-cubic mesh density function 702 takes as inputs the UV coordinates of a mesh vertex (e.g., (u, v) of input mesh 704, a minimum density c that is used as a constant for stabilization, and a mesh quality distribution multiplier A. The outputs of the bi-cubic mesh density function 702 are updated UV coordinates (u′, v′) for the non-uniform mesh 706. The bi-cubic mesh density function 702 can be expressed as follows.

$$\vec{f} ( u , v ) : ( u , v ) \to ( {u}^{′} , {v}^{′} ) \\ {u}^{′} = 4 ( c + 8 λ {‖ v - 0.5 ‖}^{3} ( 1 - c ) ) {‖ u - 0.5 ‖}^{3} + 0.5 \\ {v}^{′} = 4 ( c + 8 λ {‖ u - 0.5 ‖}^{3} ( 1 - c ) ) {‖ v - 0.5 ‖}^{3} + 0.5$$

Although FIG. 7 illustrates one example of a non-uniform mesh creation process 700, various changes may be made to FIG. 7. For example, various functions in FIG. 7 may be combined, further subdivided, replicated, or rearranged according to particular needs. Also, one or more additional functions may be included if needed or desired. In various instances, as described in this disclosure, the center area can be situated in a different area of the grid, such as based on a user gaze direction.

As also described in this disclosure, the dynamic mesh generation operation incorporates gaze data and, optionally, a defined target density, via density clamping by solving the intersection problem between a plane (defined by target density and gaze location) and the bi-cubic density function (defined with gaze data and optimized parameters). This produces a consistent high quality area defined by the plane smoothly joint with a surface low quality area. Taking advantage of the smooth distribution of grid density over the joint surface, the natural triangulation over the grids preserves its topology and aspect ratio, without the need to do any local refinement or re-meshing. This guarantees the quality and computational efficiency of the process.

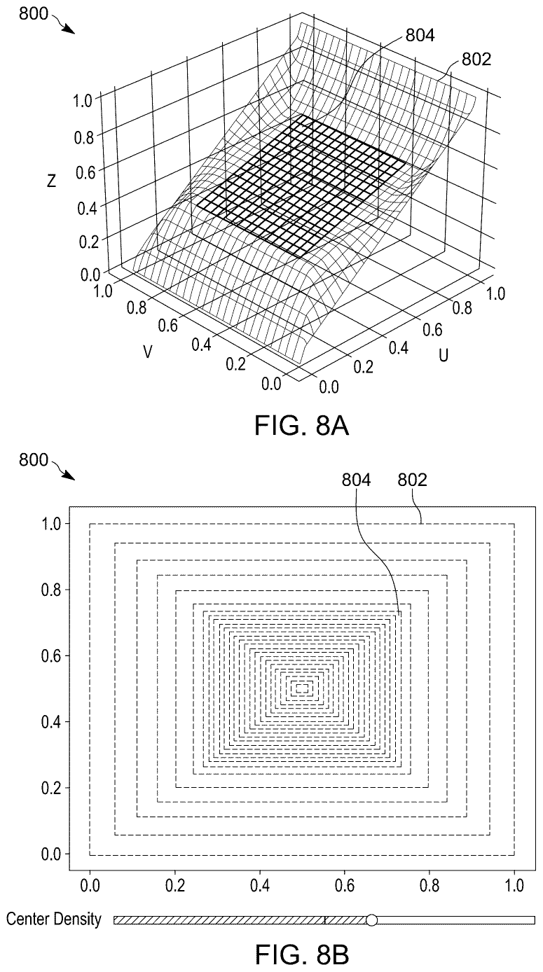

For example, FIGS. 8A and 8B illustrate an example non-uniform grid 800 in accordance with this disclosure. For ease of explanation, the non-uniform grid 800 shown in FIGS. 8A and 8B is described as being implemented on or supported by the electronic device 101 in the network configuration 100 of FIG. 1. However, the non-uniform grid 800 shown in FIGS. 8A and 8B could be used with any other suitable device(s) and in any other suitable system(s).

As shown in FIGS. 8A and 8B, a non-uniform mesh has density clamping performed on top of the bi-cubic plane surface such that a center area 804 that corresponds to a user gaze location has a higher density than other areas of the mesh 802, based on user eye tracking and lens FOV. This prioritizes computational resources on areas of the mesh 802 that the user is focused on, while spending less computational resources on areas of the mesh outside the user's gaze, which the user likely will not see anyway.

Incorporating the gaze data and a target density into the mesh density function takes as inputs the UV coordinates of a mesh vertex (u,v), a minimum density c that is used as a constant for stabilization, a mesh quality distribution multiplier λ, and, optionally, a defined target density p. The outputs of the bi-cubic mesh density function are updated UV coordinates (u′, v′) for the non-uniform mesh 802. In various embodiments of this disclosure, this process can involve computing the weighted norm (u₁, v₁) based on the uniformly distributed input (u,v), which can be expressed as follows.

$${u}_{1} = ‖ 1 - \frac{2 u}{1 + {o}_{u}} ‖ , {v}_{1} = ‖ 1 - \frac{2 v}{1 + {o}_{v}} ‖$$

The bi-cubic density surface can be defined accordingly as \vec{ƒ}(u,v): (u₁, v₁)→(u′, v′), let kᵤ=±0.5−oᵤ, kᵥ=0.5−oᵥ based on a relative position of (u,v) to the gaze center, then:

$$\vec{f} ( {u}_{1} , {v}_{1} ) = ( {k}_{u} {u}_{1}^{3} + {o}_{u} + 0 \text{.5} , {k}_{v} {v}_{1}^{3} + {o}_{v} + 0.5 )$$

If provided, the plane can be defined using the target density p, which can be expressed as follows.

$$\vec{p} ( u , v ) = ( p ( u - 0.5 ( 1 + {o}_{u} ) ) + {o}_{u} + 0.5 , p ( v - 0.5 ( 1 + {o}_{v} ) ) + {o}_{v} + 0.5 )$$

The final mesh density function can thus be defied as max (\vec{ƒ}(u₁, v₁), \vec{p}(u,v)), which involves computing the intersection curve uₛₚₗᵢₜ, vₛₚₗᵢₜ between surface \vec{ƒ} and plane \vec{p}, where the density clamping can be expressed as follows.

$${u}_{split} = \sqrt{\frac{{( 1 \pm {o}_{u} )}^{3} clamp ( c + λ ( 1 - c ) {v}_{1}^{3} , p , 1.0 )}{‖ 8 {k}_{u} ‖}} \\ {v}_{split} = \sqrt{\frac{{( 1 \pm {o}_{v} )}^{3} clamp ( c + λ ( 1 - c ) {u}_{1}^{3} , p , 1.0 )}{‖ 8 {k}_{v} ‖}}$$

Although FIGS. 8A and 8B illustrate one example of a non-uniform grid 800, various changes may be made to FIGS. 8A and 8B. For example, although FIGS. 8A and 8B illustrate the grid 800 having an example non-uniform mesh 802, the output could be in various shapes, densities, etc., depending on the nature of the image and the resulting mesh.

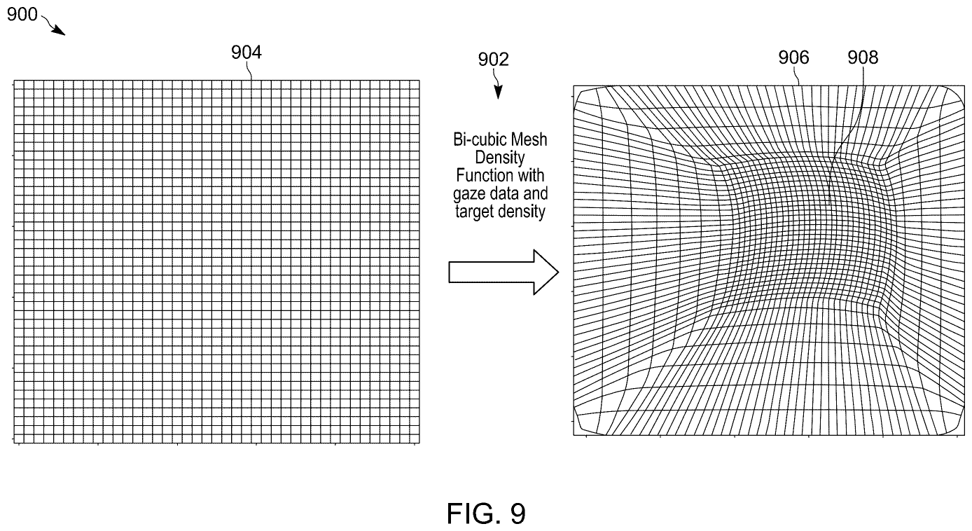

Performing the bi-cubic mesh density function while incorporating gaze data and the optional target density, as described above with respect to FIGS. 8A and 8B, can result in outputting non-uniform meshes where the dense center area is not in a center of the mesh, but in a different area of the mesh based on the user's gaze. For example, FIG. 9 illustrates an example non-uniform mesh creation process 900 incorporating gaze data and a target density in accordance with this disclosure. For ease of explanation, the process 900 shown in FIG. 9 is described as being implemented on or supported by the electronic device 101 in the network configuration 100 of FIG. 1. However, the process 900 shown in FIG. 9 could be used with any other suitable device(s) and in any other suitable system(s). The process 900 can be included as at least a part of the dynamic mesh generation operation 202.

As shown in FIG. 9, a bi-cubic mesh density function 902 that incorporates gaze data and an optional target density is performed on an input mesh 904 to produce a non-uniform mesh 906. As shown in FIG. 9, the resulting non-uniform mesh 906 has a center area 908 that is a higher density than areas surrounding the center area 908, and where the center area 908 is shifted up and to the right from an absolute center of the grid, such that the center area 908 corresponds to a current user gaze. By incorporating target density plane and gaze data into the bi-cubic mesh density function, a mesh with a better mesh density distribution for the purpose of reprojection can be generated.

Although FIG. 9 illustrates one example of a non-uniform mesh creation process 900 incorporating gaze data and a target density, various changes may be made to FIG. 9. For example, various functions in FIG. 9 may be combined, further subdivided, replicated, or rearranged according to particular needs. Also, one or more additional functions may be included if needed or desired. In various instances, as described in this disclosure, the center area can be situated in a different area of the grid, such as if the user gaze direction is in a different direction than the example shown in FIG. 9.

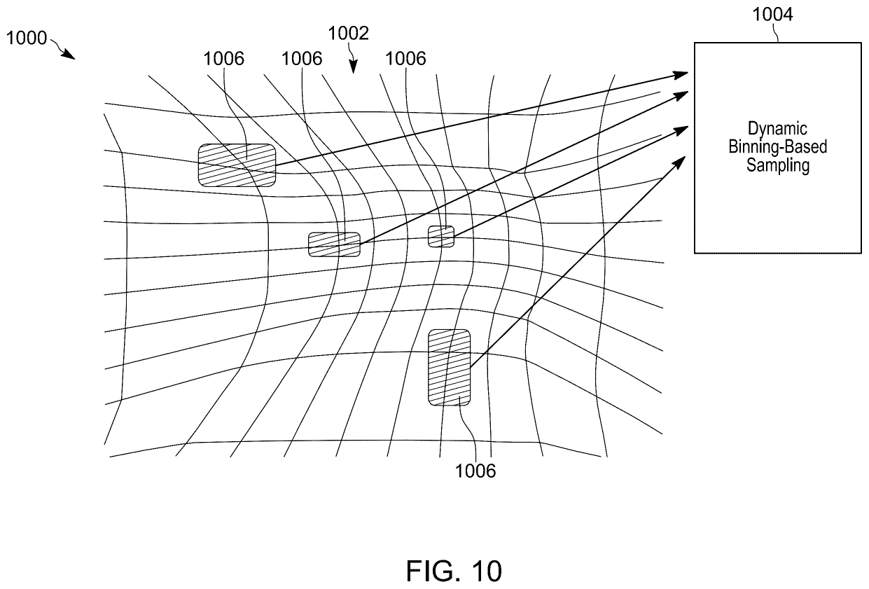

FIG. 10 illustrates an example dynamic binning process 1000 in accordance with this disclosure. For ease of explanation, the process 1000 shown in FIG. 10 is described as being implemented on or supported by the electronic device 101 in the network configuration 100 of FIG. 1. However, the process 1000 shown in FIG. 10 could be used with any other suitable device(s) and in any other suitable system(s). The process 1000 can be included as at least a part of the dynamic binning operation 204.

As shown in FIG. 10, a non-uniform mesh 1002, such as that generated using the dynamic mesh generation operation 202, is created. After obtaining the non-uniform mesh 1002, the mesh density is further computed by taking the derivatives over the joint surface. Then dynamic binning-based sampling 1004 is performed that involves dynamic binning algorithm for sampling depth and motion textures with, based on mesh density, dynamic varying bin sizes and step lengths and sampling weights. FIG. 10 shows various sampling bins 1006 defined over mesh vertices. As shown in FIG. 10, certain sampling bins 1006 are illustrated as larger or smaller than other sampling bins 1006. This is because lower density areas of the non-uniform mesh 1002 have larger bins, as the vertex for the bin is in a low density area, whereas high density areas have smaller bins. In various embodiments, as the generated mesh can still be much coarser than the high resolution color texture and low resolution warping (depth+motion) textures in most cases, smooth sampling results can be obtained using the dynamic binning-based sampling 1004. By incorporating target density plane and gaze data into the bi-cubic mesh density function, a mesh with a better mesh density distribution for the purpose of reprojection can be generated.

Although FIG. 10 illustrates one example of a dynamic binning process 1000, various changes may be made to FIG. 10. For example, various functions in FIG. 10 may be combined, further subdivided, replicated, or rearranged according to particular needs. Also, one or more additional functions may be included if needed or desired.

In various embodiments of this disclosure, an alternative modulus-based shifting approach can be used. The modulus-based shifting approach can be used to output eye-tracked foveated meshes by shifting the static non-uniform mesh by performing a modulus operation on mesh vertices based on the gaze location. This approach can be used by any type of mesh as long as the mesh has regular vertex ordering. The modulus-based shifting approach may be less effective in preserving the quality of the natural triangulation over the mesh, and thus extra effort needs to be paid for dealing with stretched triangle issues, but the modulus-based shifting approach provides an advantage over existing techniques of easily extending to different meshes with different density functions.

Also, it will be understood that low degree polynomials other than bi-cubic could be used. Generally, low-degree polynomials provide computational efficiency. Bi-linear and bi-quadratic approaches tend to not produce as much density variations for the high quality mesh as the bi-cubic approach, but still provide for efficient mesh generation. Bi-quartic functions can increase the computational complexity due to the plane-surface interaction operation, but can still provide good results on devices that meet the higher computational requirements.

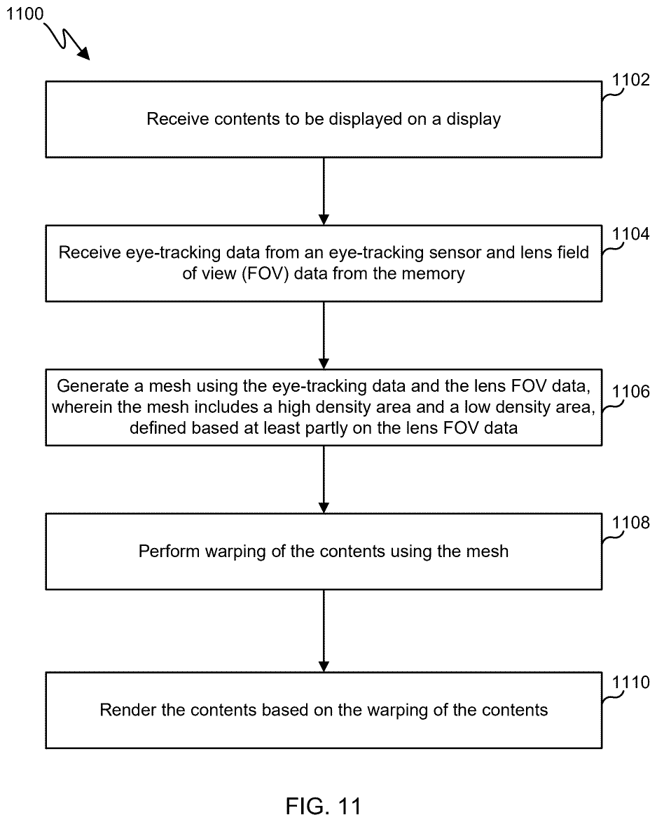

FIG. 11 illustrates an example method 1100 for dynamic non-uniform mesh generation in accordance with this disclosure. For ease of explanation, the method 1100 shown in FIG. 11 is described as being performed using the electronic device 101 in the network configuration 100 of FIG. 1. However, the method 1100 could be performed using any other suitable device(s), such as the server 106, and in any other suitable system(s).

At step 1102, contents to be displayed on a display are received. This can include an image processing device like a camera capturing an image that is obtained by the processor 120 and stored in memory. At step 1104, eye-tracking data is received from an eye-tracking sensor and lens FOV data is received from the memory. At step 1106, a mesh is generated using the eye-tracking data and the lens FOV data, where the mesh includes a high density area and a low density area, defined based at least partly on the lens FOV data. This can include performing, by the processor 120, the dynamic mesh generation operation 202.

In various embodiments, as described in this disclosure, density clamping is also performed to define the high density area of the mesh while maintaining a smooth transition between the high density area and the low density area. In various embodiments, as described in this disclosure, a low degree polynomial function can be used for computing a non-uniform density of the mesh, while incorporating the eye-tracking data and lens FOV data for determining a mesh density center and radius. In various embodiments, as described in this disclosure, the non-uniform density of the mesh can be computed using a target density value defining a target density and target size of a center area of the mesh corresponding to the mesh density center.

In various embodiments, as described in this disclosure, to generate the mesh, a mesh center location and weights are extracted, based at least partly on the eye-tracking data and lens FOV data, the low degree polynomial function is evaluated to output a smooth distribution of mesh points, the density clamping is applied to the high density area, and updated mesh positions are output. In various embodiments, as described in this disclosure, the updated mesh positions include vertex positions and UV coordinates.

In various embodiments, as described in this disclosure, perform depth reprojection and binning can be performed for generating new image frames using the updated mesh positions. At step 1108, warping of the contents is performed using the mesh. At step 1110, the contents are rendered, such as on a display of the electronic device 101, based on the warping of the contents.

Although FIG. 11 illustrates one example of a method 1100 for dynamic non-uniform mesh generation, various changes may be made to FIG. 11. For example, while shown as a series of steps, various steps in FIG. 11 could overlap, occur in parallel, occur in a different order, or occur any number of times (including zero times).

It should be noted that the functions shown in or described with respect to the figures can be implemented in an electronic device 101, 102, 104, server 106, or other device(s) in any suitable manner. For example, in some embodiments, at least some of the functions shown in or described with respect to the figures can be implemented or supported using one or more software applications or other software instructions that are executed by the processor 120 of the electronic device 101, 102, 104, server 106, or other device(s). In other embodiments, at least some of the functions shown in or described with respect to the figures can be implemented or supported using dedicated hardware components. In general, the functions shown in or described with respect to the figures can be performed using any suitable hardware or any suitable combination of hardware and software/firmware instructions. Also, the functions shown in or described with respect to the figures can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. An electronic device comprising:
a memory; and
at least one processing device operatively connected to the memory, wherein the at least one processing device is configured to:
receive contents to be displayed on a display;
receive eye-tracking data from an eye-tracking sensor and lens field of view (FOV) data from the memory;
generate a mesh using the eye-tracking data and the lens FOV data, wherein the mesh includes a high density area and a low density area, defined based at least partly on the lens FOV data;
perform warping of the contents using the mesh; and
render the contents based on the warping of the contents.

2. The electronic device of claim 1, wherein the at least one processing device is further configured to perform density clamping to define the high density area of the mesh while maintaining a smooth transition between the high density area and the low density area.

3. The electronic device of claim 2, wherein the at least one processing device is further configured to use a low degree polynomial function for computing a non-uniform density of the mesh, while incorporating the eye-tracking data and lens FOV data for determining a mesh density center and radius.

4. The electronic device of claim 3, wherein the at least one processing device is further configured to compute the non-uniform density of the mesh using a target density value defining a target density and target size of a center area of the mesh corresponding to the mesh density center.

5. The electronic device of claim 3, wherein, to generate the mesh, the at least one processing device is further configured to:
extract a mesh center location and weights, based at least partly on the eye-tracking data and lens FOV data;
evaluate the low degree polynomial function to output a smooth distribution of mesh points;
apply the density clamping to the high density area; and
output updated mesh positions.

6. The electronic device of claim 5, wherein the updated mesh positions include vertex positions and horizonal and vertical (UV) coordinates.

7. The electronic device of claim 5, wherein the at least one processing device is further configured to perform depth reprojection and binning for generating new image frames using the updated mesh positions.

8. A method comprising:
receiving, by at least one processor of an electronic device, contents to be displayed on a display;
receiving, by the at least one processor, eye-tracking data from an eye-tracking sensor and lens field of view (FOV) data from a memory of the electronic device;
generating, by the at least one processor, a mesh using the eye-tracking data and the lens FOV data, wherein the mesh includes a high density area and a low density area, defined based at least partly on the lens FOV data;
performing, by the at least one processor, warping of the contents using the mesh; and
rendering, by the at least one processor, the contents based on the warping of the contents.

9. The method of claim 8, further comprising performing, by the at least one processor, density clamping to define the high density area of the mesh while maintaining a smooth transition between the high density area and the low density area.

10. The method of claim 9, further comprising using, by the at least one processor, a low degree polynomial function for computing a non-uniform density of the mesh, while incorporating the eye-tracking data and lens FOV data for determining a mesh density center and radius.

11. The method of claim 10, further comprising computing, by the at least one processor, the non-uniform density of the mesh using a target density value defining a target density and target size of a center area of the mesh corresponding to the mesh density center.

12. The method of claim 10, wherein generating the mesh includes:
extracting a mesh center location and weights, based at least partly on the eye-tracking data and lens FOV data;
evaluating the low degree polynomial function to output a smooth distribution of mesh points;
applying the density clamping to the high density area; and
outputting updated mesh positions.

13. The method of claim 12, wherein the updated mesh positions include vertex positions and horizonal and vertical (UV) coordinates.

14. The method of claim 12, further comprising performing depth reprojection and binning for generating new image frames using the updated mesh positions.

15. A non-transitory machine-readable medium containing instructions that when executed cause at least one processor of an electronic device to:
receive contents to be displayed on a display;
receive eye-tracking data from an eye-tracking sensor and lens field of view (FOV) data from a memory;
generate a mesh using the eye-tracking data and the lens FOV data, wherein the mesh includes a high density area and a low density area, defined based at least partly on the lens FOV data;
perform warping of the contents using the mesh; and
render the contents based on the warping of the contents.

16. The non-transitory machine-readable medium of claim 15, further containing instructions that when executed cause the at least one processor to perform density clamping to define the high density area of the mesh while maintaining a smooth transition between the high density area and the low density area.

17. The non-transitory machine-readable medium of claim 16, further containing instructions that when executed cause the at least one processor to use a low degree polynomial function for computing a non-uniform density of the mesh, while incorporating the eye-tracking data and lens FOV data for determining a mesh density center and radius.

18. The non-transitory machine-readable medium of claim 17, further containing instructions that when executed cause the at least one processor to compute the non-uniform density of the mesh using a target density value defining a target density and target size of a center area of the mesh corresponding to the mesh density center.

19. The non-transitory machine-readable medium of claim 17, wherein, the instructions that when executed cause the at least one processor to generate the mesh further include instructions that when executed cause the at least one processor to:
extract a mesh center location and weights, based at least partly on the eye-tracking data and lens FOV data;
evaluate the low degree polynomial function to output a smooth distribution of mesh points;
apply the density clamping to the high density area; and
output updated mesh positions including vertex positions and horizonal and vertical (UV) coordinates.

20. The non-transitory machine-readable medium of claim 19, further containing instructions that when executed cause the at least one processor to perform depth reprojection and binning for generating new image frames using the updated mesh positions.
